(19) United States
(12) Patent Application Publication
(10) Pub. No.: US 2012/0009002 A1
(43) Pub. Date: Jan. 12, 2012

(54) APPLICATOR DEVICE

(75) Inventors: Patrick Ping Sun Lo, Hong Kong SAR (CN); Patrick Hok Yuk Cheung, Hong Kong SAR (CN)

(73) Assignee: HCP INNOVATIONS HONG KONG LIMITED, Hong Kong SAR (CN)

(21) Appl. No.: 12/833,294

(22) Filed: Jul. 9, 2010

(51) Int. Cl. A46B 5/02; B43K 29/00

(52) U.S. Cl. 401/6; 401/195

(57) ABSTRACT

An applicator device, including a holder for holding a substance, an applicator for applying the substance, and a temperature control circuit for controlling the temperature of the applicator and the substance to be applied by the applicator. The temperature control circuit includes a microprocessor unit for control and a temperature changing element located in close proximity to the applicator for changing the temperature of the applicator to a predetermined temperature under the control of the microprocessor unit.

The present invention relates to an applicator device for holding and applying a substance.

### FIELD OF THE INVENTION

The applicator device of the invention may take any physical form or design, and it is made for holding and applying particularly, but not exclusively, cosmetic substance or makeup formulation such as lipstick, lip gloss, foundation, mascara, eye shadow, eyeliner or the like. Examples of other intended substances are medical ointment, aromatic oil, perfume, massage gel, hair styling products and glue, etc. The types of substances are practically unlimited.

### BACKGROUND OF THE INVENTION

Most substances have a preferred range of temperature for optimal performance and/or to achieve the best result. Some substance will become dissatisfactory as the formulation ages, and then temperature may become more of a concern. Users may experience considerable coagulation of the substance on the areas to be applied, thereby reducing the desired effectiveness of the substance.

People are not always in control of the temperature in which they apply and use substances or formulations. Indoor ambient temperature is often controllable or at least allowed for by formulation suppliers, but when it comes to outdoor environments temperature can vary in a wide range dependent upon the weather or season.

In cold temperature, although a heater may be used to preheat a substance before use, this is cumbersome. A desired temperature may readily be attainable if the heater has built-in temperature control, but applying the heat to the substance can be tricky especially if one only wants to raise the temperature of a small amount of the substance for use. On the other hand, increasing the temperature of the whole quantity of substance is overkill and in any event will require a protracted period of time.

The invention seeks to mitigate or at least to alleviate such a problem by providing a new or otherwise improved application device for holding and applying a substance, which can control the temperature of the substance in order to enhance its application effectiveness.

### SUMMARY OF THE INVENTION

According to the invention, there is provided an applicator device for applying a substance, comprising a holder for holding a said substance, an applicator for applying a said substance, and a temperature control circuit for controlling the temperature of the applicator and hence a said substance to be applied by the applicator. The temperature control circuit comprises a microprocessor unit for control and a temperature changing element located at close proximity to the applicator for changing the temperature of the applicator to a predetermined value under the control of the microprocessor unit.

Preferably, the applicator is connected with a body in which the temperature control circuit is housed, the body providing a finger grip by which the applicator may be held and manipulated by a user.

More preferably, the body includes a compartment for locating a battery for powering the temperature changing element.

In a preferred embodiment, the body is releasably engaged with the holder, with the applicator inserted into the holder, together forming a one-piece structure when the applicator device is not in use.

More preferably, the applicator protrudes from the body, together forming an elongate structure and extending along a common axis.

It is preferred that the applicator comprises a brush.

In another preferred embodiment, the body with the applicator is removably accommodated wholly inside the holder when the applicator device is not in use.

More preferably, the applicator is at least in part of one of a sponge and fabric material.

In yet another embodiment, the body has a front part with which the applicator is connected and a rear part comprising the holder, such that a said substance in the holder can be dispensed via the applicator.

More preferably, the rear part of the body provides the holder.

It is preferred that the applicator is at least in part of one of a sponge and fabric material.

It is preferred that the applicator comprises one of a nozzle and spray head.

Preferably, the temperature control circuit is adapted to increase the temperature of the applicator at a rate of at least about 1° C. per second.

More preferably, the temperature control circuit includes a switching circuit controlled by the microprocessor unit to connect the temperature changing element substantially directly across a power source for increasing the temperature of the applicator.

In a preferred embodiment, the temperature control circuit includes a temperature sensor located at close proximity to the applicator for providing a signal indicative of the temperature of the applicator to the microprocessor unit for the microprocessor unit to maintain the temperature of the applicator at or about the predetermined value.

Preferably, the temperature sensor comprises a thermistor.

Preferably, the microprocessor unit operatively maintains the temperature of the applicator within +/−2° C. about the predetermined value.

It is preferred that the temperature control circuit includes a switch enabling user selection of one of a plurality of predetermined values for the temperature of the applicator.

It is preferred that the temperature control circuit includes an indicator adapted to indicate when the temperature of the applicator reaches the predetermined value.

It is further preferred the indicator is adapted to also indicate at least one of when the temperature control circuit is switched on and when the temperature changing element is changing the temperature of the applicator.

Preferably, the indicator comprises a light indicator.

It is an advantage that the temperature control circuit has an auto-timer function for automatically switching off the temperature changing element at the end of a predetermined operating period.

### BRIEF DESCRIPTION OF DRAWINGS

The invention will now be more particularly described, by way of example only, with reference to the accompanying drawings, in which:

FIG. 1 is an exploded perspective view of an applicator device, in the form of a mascara applicator, embodying the invention, showing various components thereof;

FIG. 2 is a cross-sectional side view of a bottle of the mascara applicator of FIG. 1, for holding liquid mascara;

FIGS. 3A and 3B are front and side views of a body of the mascara applicator of FIG. 1;

FIGS. 4A and 4B are side views of two alternative brushes of the mascara applicator of FIG. 1;

FIGS. 5A and 5B are side views of two battery contacts of the mascara applicator of FIG. 1;

FIG. 5C is a rear view of a lid of a battery compartment of the mascara applicator of FIG. 1;

FIGS. 6A and 6B are front and side views of an outer casing for the body of the mascara applicator of FIG. 1;

FIG. 7 is a side view of a temperature control circuit of the mascara applicator of FIG. 1;

FIG. 8 is a side view of a heating wire wound on a rod of the mascara applicator of FIG. 1;

FIG. 9 is a detailed circuit diagram of the temperature control circuit of FIG. 7; and

FIG. 10 is a schematic functional block diagram of the temperature control circuit of FIG. 9.

### DETAILED DESCRIPTION OF THE INVENTION

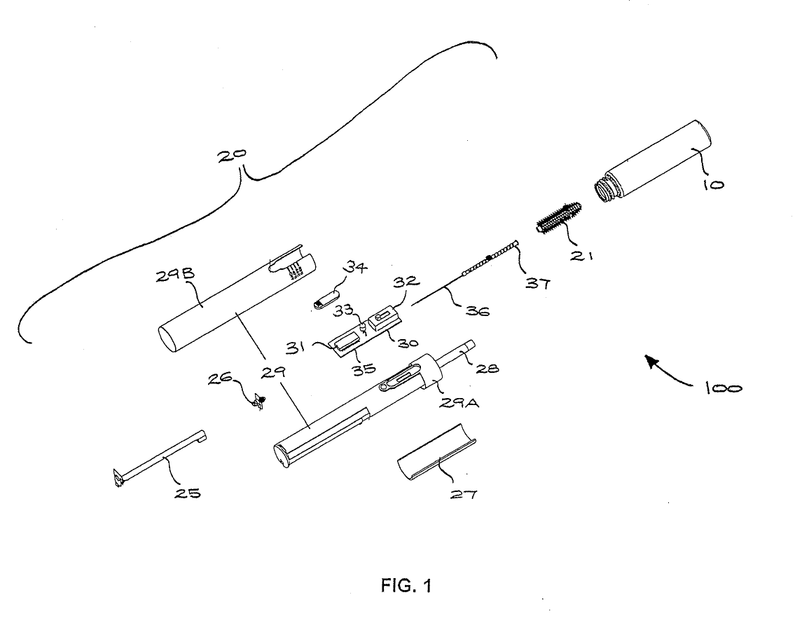

Referring initially to FIGS. 1 to 8 of the drawings, there is shown an applicator device for applying a substance embodying the invention, which in this particular embodiment is a mascara applicator 100. The mascara applicator 100 has a cylindrical bottle 10 for holding liquid mascara, an applicator 20 comprising a cylindrical brush 21 for applying liquid mascara taken out from the bottle 10, and a temperature control circuit 30 for controlling the temperature of the applicator 20 and in particular the brush 21 and hence the liquid mascara to be applied by the brush 21.

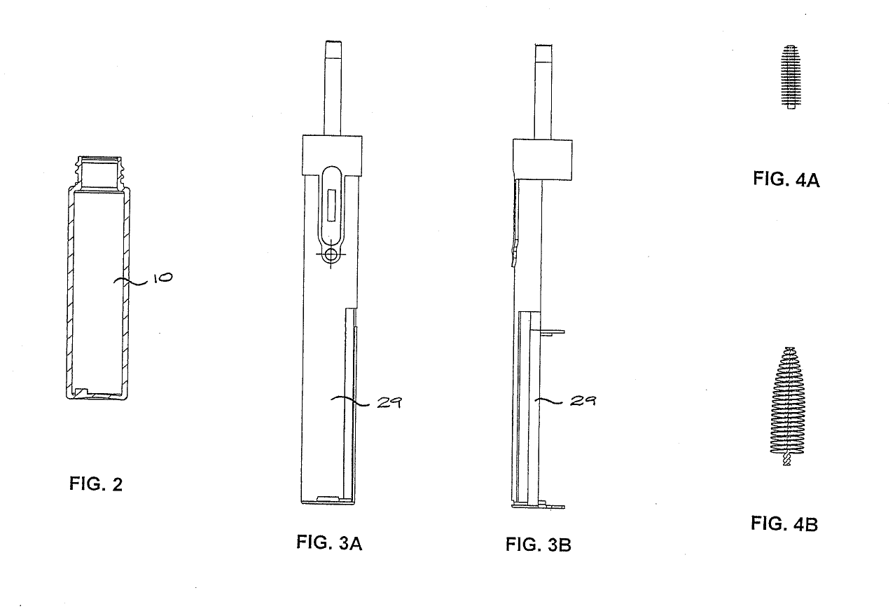

The bottle 10 is a slender cylindrical bottle (FIG. 2) preferably made of polystyrene material and may have different shapes and sizes, and is suitable for containing any liquid/semi-liquid formulation, including gel, cream and lotion for example.

The applicator 20 includes a slender cylindrical body 29 made of polystyrene and having a tubular shaft 28 which projects co-axially from a front end 29A of the body 29 (FIG. 3), and to the tip of which the brush 21 is co-connected and hence supported. The brush 21 has a tubular core into which the shaft 28 is inserted, whereby the brush 21 is disposed co-axially on the shaft 28. The body 29 with its shaft 28 and the brush 21 supported thereon together form an elongate structure extending along a common axis.

The brush 21 is made of Acrylonitrile butadiene styrene plastics i.e. ABS, which is a material preferred as it combines the strength/rigidity of acrylonitrile and styrene polymers with the toughness of polybutadiene rubber. This material also has good impact resistance and toughness as well as excellent electrical insulation properties, within a temperature range from −40° C. to 100° C. The brush 21 may be made in different designs or dimensions (FIGS. 4A and 4B), dependent upon the properties e.g. fluidity of the formulation and how it is to be applied.

The body 29 has its end 29A adapted and used as a cap for screwing onto an open end of the bottle 10 to close the same, whereby the body 29 releasably engages end-to-end with the bottle 10, together forming a one-piece structure when the mascara applicator 100 is not in use. The shaft 28 with the brush 21 is inserted into the bottle 10 under this condition, or it is insertable for the brush 21 to dip into and extract the liquid mascara.

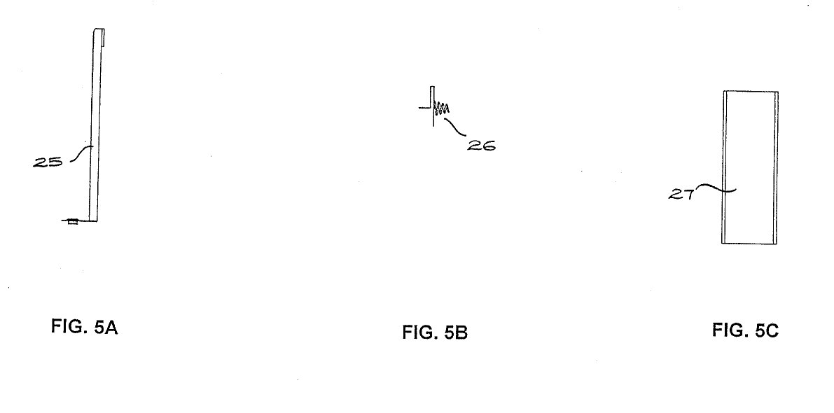

The body 29 houses the temperature control circuit 30 in the front and also provides a battery compartment in the rear for locating a 1.5V battery cell as the power source for the temperature control circuit 30. The battery compartment is fitted with battery contacts 25 and 26 (FIGS. 5A and 5B) and closed by a lid 27 (FIG. 5C). In general, the battery cell may be a Ni-cd, alkaline, carbon zinc, mercury or rechargeable battery for example, and may be of an AA or AAA size.

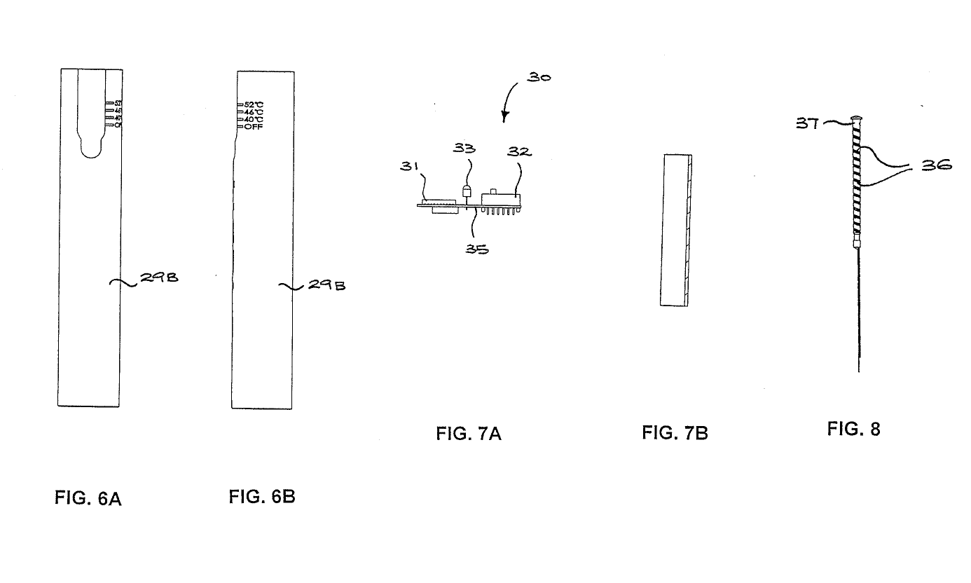

A matching cylindrical outer casing 29B (FIGS. 6A and 6B) gives the body 29 a neat external appearance and finish, together providing a finger grip or handle by which the applicator 20 may be held such that the brush 21 may be manipulated by a user to apply liquid mascara to her eyelashes. The casing 29B also provides a surface for printing or engraving a company name and logo, or for a sticker bearing the same.

Extensive studies and researches show that the most favorable temperature for mascara formulations falls in the range from 40° C. to 52° C., under which the performance of liquid mascaras is optimal, especially in terms of fluidity and application effectiveness.

The temperature control circuit 30 is built based on a microprocessor unit or MPU 31 and includes a slide switch 32 and a tri-color LED 33 for user control and indication, all being mounted on a printed circuit board or PCB 35 (FIG. 7). The MPU 31 is an 8-bit microprocessor or microcontroller chip available in the market under number EM78P153S. Also included is a temperature changing element in the form of an electrical heating wire 36 made of tungsten, which is located in close proximity to the brush 21 for changing the temperature of the brush 21 to a predetermined value under the control of the MPU 31.

The heating wire 36 is wound on a rod 37 (FIG. 8), which is in turn located in the hollow shaft 28 of the body 29. The front end of the rod 37 with the heating wire 36 thereon protrudes from the free end of the shaft 28, over which the brush 21 is disposed, such that the heating wire 36 is embedded within the brush 21 for controlling its temperature.

The slide switch 32 is operated by means of a knob 34 which is exposed through a cutout at the front end of the casing 29B for manual operation. The switch 32 has a series of three ON positions for setting the temperature of the brush 21 at 40° C., 46° C. and 52° C. as desired, and an OFF position. These four switching positions are indicated by respective markings along one side of the cutout (FIG. 6B), against which the knob 34 may be slid to operate the switch 32 and hence the temperature control circuit 30.

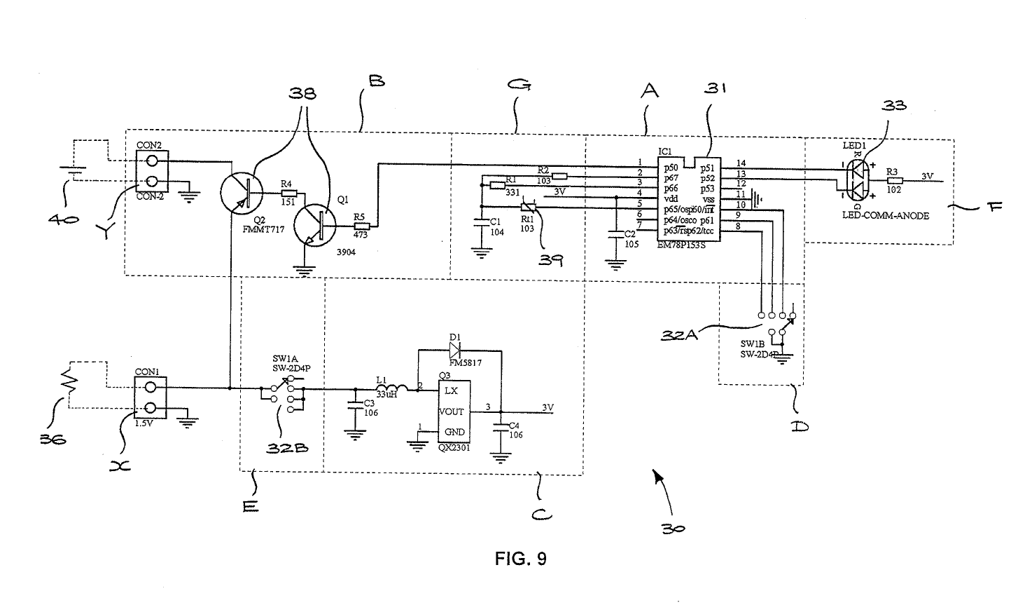

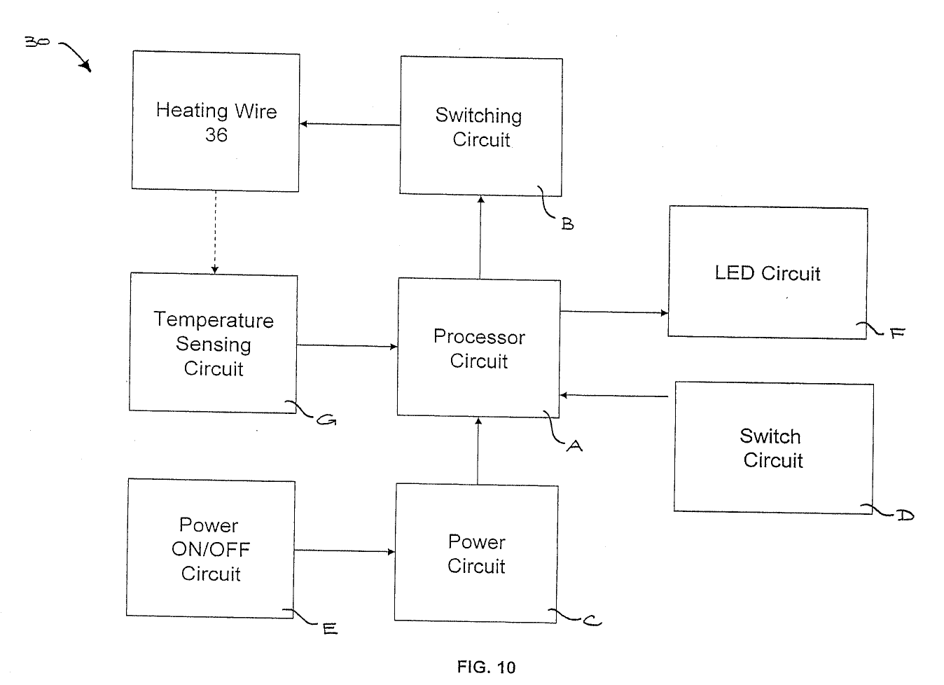

Referring also to FIGS. 9 and 10, the temperature control circuit 30 shown therein is an important part of the mascara applicator 100. The control circuit 30 has a first pair of terminals X connected to battery contacts 25 and 26 for connecting a battery cell 40 in the battery compartment, and a second pair of terminals Y connected to opposite ends of the heating wire 36.

The heart of the temperature control circuit 30 is the MPU 31, which constitutes a processor circuit A. The control circuit 30 includes a switching circuit B controlled by the processor circuit A, and a power circuit C for supplying power to the processor circuit A and the switching circuit B. The switching circuit B is formed by a pair of cascaded transistor switches 38 for connecting the heating wire 36 (connected to the circuit terminals Y) to the battery cell (connected to the circuit terminals X), or disconnecting it therefrom, based on a control signal from pin 1 of the MPU 31. In operation, the transistor switches 38 connect the heating wire 36 directly across the battery cell 40 (with the other connection via the ground), whereby the heating wire 36 receives maximum power from the battery cell 40 for quickest possible heating up.

The power circuit C is essentially a PFM (i.e. Pulse Frequency Modulation) step-up DC-to-DC converter for increasing the 1.5V battery voltage to a regulated voltage of 3.0V for powering the MPU 31 at its pin 4 and the LED 33.

The switch 32 is formed by a pair of 1P-4T switches 32A and 32B, labeled as switch circuit D and power on/off circuit E respectively, operated simultaneously by the sliding knob 34. The first switch 32A offers its first, second and third throw terminals connected to pins 8, 9 and 10 of the MPU 31 respectively, with its pole terminal to the ground, for enabling user selection of the temperature of the heating wire 36 and in turn the brush 21 at 40° C., 46° C. or 52° C. respectively. The second switch 32B is connected, with its pole and fourth throw terminals, in series between the circuit terminals X and the power circuit C for connecting or disconnecting the battery cell 40, thereby switching on and off the control circuit 30.

The LED 33, which is the core of an LED circuit F, is powered by the 3V output of the power circuit C and controlled by pins 13 and 14 of the MPU 31 to light up in green, yellow and red, usually sequentially, to provide visual indication of the operating status of the overall control circuit 30. More specifically, the green light indicates that the control circuit 30 has just been powered on. The yellow light indicates that the heating wire 36 and in turn the brush 21 is being heated up (or cooling down). The red light indicates that the brush 21 has reached the selected temperature.

It is envisaged that the light indication provided by the LED 33 may be replaced by audio indication, such as a short beep signifying power-on and a long (or double) beep to signifying reaching of the desired temperature.

The control circuit 30 further includes a temperature sensing circuit G for sensing the temperature of the brush 21 via the heating wire 36. The temperature sensing circuit G incorporates a thermistor 39 connected to pin 5 (symbol P65) of the MPU 31, two resistors R2 and R1 connected to pin (symbol P67) and pin 3 (symbol P66) respectively and a capacitor C1 to the ground, all from a common node, as shown in FIG. 9.

The thermistor 39 is physically embedded in the front end of the rod 37, around which the heating wire 36 is wound and on which the brush 21 is disposed. The thermistor 39 will sense and respond to, by changing its resistance, the heat in the vicinity of the brush 21 generated by the heating wire 36. The change in the resistance of the thermistor 39 provides a signal to the MPU 31 indicative of the temperature of the brush 21 and hence the liquid mascara thereon.

The temperature sensing circuit G provides a feedback signal to the MPU 21 indicative of the temperature of the brush 21 for regulating the temperature of the liquid mascara being heated. More specifically, if the temperature of the liquid mascara (i.e. the brush 21) has not yet reached the selected temperature (i.e. 40° C., 46° C. or 52° C.), the MPU 21 will keep the switching circuit B on until the liquid mascara is heated up to or above the selected temperature (within tolerance of up to +/−2° C.). As soon as the liquid mascara cools down below the desired temperature (with similar tolerance), the MPU 21 will turn on the switching circuit B to re-heat the liquid mascara until it reaches the desired temperature again, thereby maintaining the temperature of the liquid mascara at or about the predetermined or desired temperature.

The operation of the MPU 21 and connected components of the temperature sensing circuit G is now described in some detail. Pin 3 of the MPU 31 is switched to a low impedance state that discharges capacitor C1 through resistor R1. Pins 3 and 5 are then switched to a high impedance input state. Pin 2 is switched to output high state (a 3V output) that charges capacitor C1 through resistor R2. The time interval between the instance that pin 2 switches from low to high up to the instance that pin 3 detects a high voltage, i.e. a logic 0 to a logic 1, is recorded as a comparison index. The aforesaid steps are repeated except that the roles of pins 2 and 5 are switched, as are resistor R2 and thermistor 39. This method has an accuracy of +/−1° C. between the range 10° C. to 52° C. and +/−2° C. above 52° C. to 70° C.

In general, the basic operation of the other circuit blocks of the temperature control circuit 30, to the extent that it has not been explicitly described above, would be apparent to persons skilled in the art.

A laboratory test was conducted on the performance of the heating function of the mascara applicator 100. During that test, under the control of the temperature control circuit 30, the brush 21 was heated up from about 23° C. (i.e. the room temperature) to about 37° C. in approximately 20 seconds and was subsequently maintained in the region between 36° C. and 38° C. for several minutes.

The rate of the temperature rise was therefore approximately 0.7° C./s (i.e. 14° C./20 s). This rate is only specific to the applicator sample tested and there is of course room for improvement. The preferred rate is at least 1° C./s, which has been successfully achieved in recent tests. A key factor to the rate of temperature rise is the strength of the electrical power source employed, and batteries of the known or future high-power types such as Li-ion and Li polymer batteries are preferred. Balance is to be struck between the speed of rise in temperature and the cost and size of the battery utilized.

Of comparable importance is the ability to subsequently maintain the desired temperature of the brush 21 reasonably constant or within a small tolerance to enable the mascara formulation to achieve the best result and for an extended operating period as is sufficiently long for applying the mascara. The preferred tolerance is +/−1° C. for 10° C. to 52° C. and +/−2° C. for 52° C. to 70° C. The temperature is maintained through the use of the feedback signal provided by the temperature sensing circuit G as described above. The operating period is preferably preset to be three minutes.

The MPU 31 is programmed to automatically turn off the switching circuit B, thereby cutting off the heating wire 36, at the end of the preset operating period. Such an auto-timer function is useful in not only ensuring safety but also in minimizing power wastage to thereby prolong the operating life of the battery 40. Should the auto-timer function be invoked, the user may slide the switch 32 to the OFF position and then back to the desired temperature so as to re-activate the heating wire 36.

In general, the temperature control circuit 30 provides the mascara applicator 100 with three main functions: (i) user-selection of various temperature settings, (ii) rapid rising (or dropping) to the selected temperature, (iii) maintaining the selected temperature, and (iv) auto-timer control.

The general design in the construction of the applicator device 100 as described above is also suitable for use on some other liquid formulations such as lip gross and nail polish or even glue. The tip of the applicator may be fitted with sponge, fabric or the like material, instead of a brush 21.

Certain other liquid substances are held in and dispensed from a bottle and applied via a dispensing device at the top or front of the bottle, for example on a cap closing the bottle. The dispensing device may be a piece of sponge or similar liquid-permeable material, a nozzle with a slit valve to control the flow, or a pressurized or pump-type spray head. The liquid substance is squeezed or sprayed out through the sponge/nozzle or the spray head and then applied directly to a surface.

The temperature changing element of the subject invention may be installed in the cap in or behind the sponge, nozzle or spray head for heating the small quantity of liquid substance that is being dispensed. Formulations that are suitable for use with this type of applicator devices include medical ointment, aromatic oil, massage gel, glue, perfume and hair styling products.

Powder-based make-up formulations, such as foundation and eye shadow, are usually packaged in a flat box, which also holds an applicator in the form of a foundation sponge or sponge stick for extracting and applying the powder-based formulation. Such an applicator is removably accommodated wholly inside the box when it is not in use.

The foundation sponge or sponge stick may be installed with a temperature changing element for adjusting the temperature of the powder thereon. If the sponge stick is too small to hold a battery cell, the battery may be located in the box for powering the heater in the stick via thin electric wires or detachable electrical connection.

In a broader context, the temperature changing element of the applicator device of the invention may be a cooler, instead of a heater as in the described embodiment. Such a cooling device may operate based on the refrigerator or air-conditioner principle, or rely on the use of suitable chemicals that can be mixed to react and produce a cooling effect (i.e. absorbing heat) under the control of a microprocessor-based control circuit, or involve the use of liquid nitrogen stored in a small capsule or cylinder which can be released via a valve under microprocessor control to provide cooling in a controlled manner.

With the use of the present invention, the effectiveness of application of substance can be enhanced with optimal heating and/or cooling of the substance. This is achieved through heating and/or cooling of the applicator tip made of synthetic bristles, sponge, comb or any material that is suitable for application of the substance. When a small quantity of the substance is loaded onto the applicator tip, it is being warmed up or cooled down to the optimal temperature. As a result, when applied onto the desired area, the user will experience greater ease in application of the substance, in turn enhancing the effectiveness. By the same token and method of usage, any other substance that can benefit from the heating and/or cooling functions can be applied within the scope of the invention.

The invention has been given by way of example only, and various modifications of and/or alterations to the described embodiments may be made by persons skilled in the art without departing from the scope of the invention as specified in the appended claims.

1. An applicator device comprising:
a holder for holding a substance;
an applicator for applying the substance; and
a temperature control circuit for controlling temperature of the applicator and the substance to be applied by the applicator, wherein the temperature control circuit comprises
a microprocessor unit for control, and
a temperature changing element located in close proximity to the applicator for changing the temperature of the applicator to a predetermined temperature under control of the microprocessor unit.

2. The applicator device as claimed in claim 1, including a body in which the temperature control circuit is housed, the body being connected to the applicator and providing a finger grip by which the applicator may be held and manipulated by a user.

3. The applicator device as claimed in claim 2, wherein the body includes a compartment for a battery powering the temperature changing element.

4. The applicator device as claimed in claim 2, wherein the body is releasably engageable with the holder, the body, when engaged with the applicator, being inserted within the holder, the applicator and the holder together forming a one-piece structure when the applicator device is not in use.

5. The applicator device as claimed in claim 4, wherein
the applicator protrudes from the body, and
the applicator and the body, when engaged, together form an elongate structure, with the body and applicator extending along a common axis.

6. The applicator device as claimed in claim 4, wherein the applicator comprises a brush.

7. The applicator device as claimed in claim 2, wherein the body with the applicator is removably accommodated wholly inside the holder when the applicator device is not in use.

8. The applicator device as claimed in claim 7, wherein the applicator, is at least in part, one of a sponge and a fabric.

9. The applicator device as claimed in claim 2, wherein the body has a front part with which the applicator is connected and a rear part comprising the holder, such that a the substance in the holder can be dispensed via the applicator.

10. The applicator device as claimed in claim 9, wherein the rear part of the body provides the holder.

11. The applicator device as claimed in claim 9, wherein the applicator is, at least in part, one of a sponge and a fabric.

12. The applicator device as claimed in claim 9, wherein the applicator comprises one of a nozzle and a spray head.

13. The applicator device as claimed in claim 1, wherein the temperature control circuit increases the temperature of the applicator at a rate of at least about 1° C. per second.

14. The applicator device as claimed in claim 13, wherein the temperature control circuit includes a switching circuit controlled by the microprocessor unit, and connecting the temperature changing element substantially directly across a power source for increasing the temperature of the applicator.

15. The applicator device as claimed in claim 1, wherein
the temperature control circuit includes a temperature sensor located in close proximity to the applicator for providing a signal indicative of the temperature of the applicator to the microprocessor unit, and
the microprocessor unit maintains the temperature of the applicator at or about the predetermined temperature.

16. The applicator device as claimed in claim 15, wherein the temperature sensor comprises a thermistor.

17. The applicator device as claimed in claim 15, wherein the microprocessor unit operatively maintains the temperature of the applicator within +/−2° C. about the predetermined temperature.

18. The applicator device as claimed in claim 1, wherein the temperature control circuit includes a switch enabling user selection of one of a plurality of predetermined temperatures of the applicator.

19. The applicator device as claimed in claim 1, wherein the temperature control circuit includes an indicator indicating when the temperature of the applicator reaches the predetermined temperature.

20. The applicator device as claimed in claim 19, wherein the indicator indicates at least one of state of the temperature control circuit and changing of the temperature of the applicator by the temperature changing element.

21. The applicator device as claimed in claim 19, wherein the indicator comprises a light.

22. The applicator device as claimed in claim 1, wherein the temperature control circuit has an auto-timer function for automatically switching off the temperature changing element at the end of a predetermined operating period.
